(19) United States
(12) Patent Application Publication
(10) Pub. No.: US 2015/0364051 A1
(43) Pub. Date: Dec. 17, 2015

(54) GENERATING A COMPREHENSION INDICATOR THAT INDICATES HOW WELL AN INDIVIDUAL UNDERSTOOD THE SUBJECT MATTER COVERED BY A TEST

(71) Applicant: Apollo Education Group, Inc., Phoenix, AZ (US)

(72) Inventors: Rajaa Mohamad Abdul Razack, Cupertino, CA (US); Kolla Venkata Ramana, Andhra Pradesh (IN); Pavan Aripirala Venkata, Fremont, CA (US); Narender Vattikonda, San Jose, CA (US); Nagaraju Aerra, Andhra Pradesh (IN)

(21) Appl. No.: 14/302,645

(22) Filed: Jun. 12, 2014

(51) Int. Cl. G09B 7/00

(52) U.S. Cl. CPC G09B 7/00

(57) ABSTRACT

A method and system are provided for generating a comprehension indicator that indicates how well an individual understood the subject matter covered by a test. In one implementation, a question-level comprehension indicator is generated for each of the questions on the test. The question-level comprehension indicators may be generated based upon one or more question-level factors, which may include behavioral aspects of the individual while taking the test. After the question-level comprehension indicators are generated, they may be used to generate a first test-level comprehension indicator. A second test-level comprehension indicator may also be generated. Unlike the first test-level comprehension indicator, the second test-level comprehension indicator is generated based upon test level rather than question level factors. After the first and second test-level comprehension indicators are generated, they may be used to derive an overall comprehension indicator for the individual for that test. The overall comprehension indicator may then be used in addition to or in lieu of a test score to determine how well the individual understood the subject matter covered by the test, as well as other purposes.

### FIELD OF THE INVENTION

The present invention relates generally to computing systems and more particularly to a method and system for generating a comprehension indicator that indicates how well an individual understood the subject matter covered by a test.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

In a typical educational course, a student is provided with sets of educational materials to study and learn. These materials may take the form of texts, lectures, audio/visual content, etc., that teach one or more concepts. At some point during the course, the student is given a test to assess how well he/she has learned the educational materials. The result of the test is usually a numerical score, and this score is typically taken as the measure of how well the student understood or comprehended the subject matter covered by the test.

While a test score does provide some indication of how well a student comprehended the subject matter covered by a test, it often does not paint a complete picture. In fact, the test score may sometimes provide a misleading indication of how well a student understood the subject matter. For example, two students having the same test score may have had very different levels of comprehension of the subject matter. For instance, one of the students may have fully grasped the concepts tested by the test and may have answered the questions correctly because of this comprehension, while the other student may have guessed on a number of the questions and simply got lucky in selecting the correct answers. Even if both students answered the questions correctly because they understood the subject matter, one student may have answered the questions quickly and easily while the other may have labored for a much longer time on the test and may have struggled and even changed his/her answers several times on some of the questions. Thus, just because two students achieved the same test score on the same test does not necessarily mean that they had the same level of comprehension of the subject matter. In many instances, it would be desirable to get a better reading of the level of comprehension of a student as that reading may help an educator decide whether a student has mastered certain concepts, and hence can move on to other concepts, or whether the student should devote additional attention to the current concepts before moving on to other concepts. Consequently, a need exists for a comprehension indicator that can be used in addition to or in lieu of a test score to determine how well a student understood the subject matter covered by a test.

### BRIEF DESCRIPTION OF THE DRAWINGS

FIG. 1 is a functional block diagram of a system in which one embodiment of the present invention may be implemented.

FIG. 2 is a functional block diagram depicting the micro level generator of FIG. 1 in greater detail, in accordance with one embodiment of the present invention.

FIG. 3 is a functional block diagram depicting the macro level generator of FIG. 1 in greater detail, in accordance with one embodiment of the present invention.

FIG. 4 is a block diagram of a sample computer system that may be used to implement at least a portion of the present invention.

### DETAILED DESCRIPTION OF EMBODIMENT(S)

### Overview

In accordance with one embodiment of the present invention, a method and system are provided for generating a comprehension indicator that indicates how well an individual understood the subject matter covered by a test.

According to one embodiment, a test-level comprehension indicator is generated based upon a plurality of question-level comprehension indicators. More specifically, for each test question on a test that is taken by an individual, a question-level comprehension indicator is generated for that question that indicates how well the individual understood the concept or concepts tested by that question. The question-level comprehension indicator may be generated based upon one or more factors. These factors may include, but are not limited to, whether the individual answered the question correctly, how much time the individual spent on that question, whether and how many times the individual skipped that question (i.e. selected that question but did not provide a response before selecting another question), whether and how many times the individual changed his/her response to that question, the concept or concepts covered by that question, the difficulty level of that question, the type of the question (e.g. multiple choice or fill-in), etc. As can be seen, at least some of these factors pertain to the behavior of the individual while taking the test. The individual's test taking behavior can provide insight into the level of comprehension of the subject matter. After a question-level comprehension indicator is generated for each of the questions on the test, a test-level comprehension indicator may be generated based upon the question-level comprehension indicators. For example, the test-level comprehension indicator may be an average or a weighted average of the question-level comprehension indicators of the individual questions. Once this test-level comprehension indicator is generated, it may be used as the overall comprehension indicator for the individual for that test, or it may be used in conjunction with one or more other test-level comprehension indicators to generate an overall comprehension indicator for the individual for that test.

In one embodiment, a second test-level comprehension indicator may be generated and used in conjunction with the first test-level comprehension indicator discussed above to generate an overall comprehension indicator. Unlike the first test-level comprehension indicator, which is generated based upon the question-level comprehension indicators of the individual test questions, the second test-level indicator is generated based upon a set of test-level rather than question-level factors. These test-level factors may include, but are not limited to, how much time the individual spent on the entire test, whether the responses provided by the individual form certain discernable patterns (e.g. ccccc or abcdabcd, etc.) that may indicate guessing, whether the individual targeted questions with certain point values, how well the individual performed on specific concepts covered by the test, how many questions the individual answered in a last time segment of the test (e.g. if the individual answered many questions in the last minute of the test, there is a likelihood that the individual guessed on at least some of those questions), etc. Since the second test-level comprehension indicator takes into account higher level or macro level factors, it may be viewed as a macro level indicator, whereas the first test-level comprehension indicator, which takes into account question-level factors, may be viewed as a lower level or micro level indicator.

Once generated, the first and second test-level comprehension indicators may be used to generate an overall comprehension indicator for the individual for that test. For example, the overall comprehension indicator may be an average or a weighted average of the first and second test-level comprehension indicators.

Once generated, the overall comprehension indicator may be used for various purposes. For example, if the overall comprehension indicator indicates that an individual is not as proficient as his/her test score may suggest, then it may be recommended that the individual devote additional study to one or more concepts covered by the test. On the other hand, if the overall comprehension indicator indicates that the individual has indeed mastered the concepts covered by the test, then the individual may be allowed to move on to other concepts. Also, based upon the overall comprehension indicators of a plurality of individuals who have taken a test, an educator may determine how effective a set of teaching materials is at teaching the subject matter covered by the test. The educator may also use the overall comprehension indicators of a plurality of individuals to determine how effective his/her teaching methods are. Based upon these determinations, the educator may change the teaching materials and/or his/her teaching methods. In these and other ways, the overall comprehension indicator may be used in addition to or in lieu of a test score to improve the educational experience of one or more individuals.

### Sample System

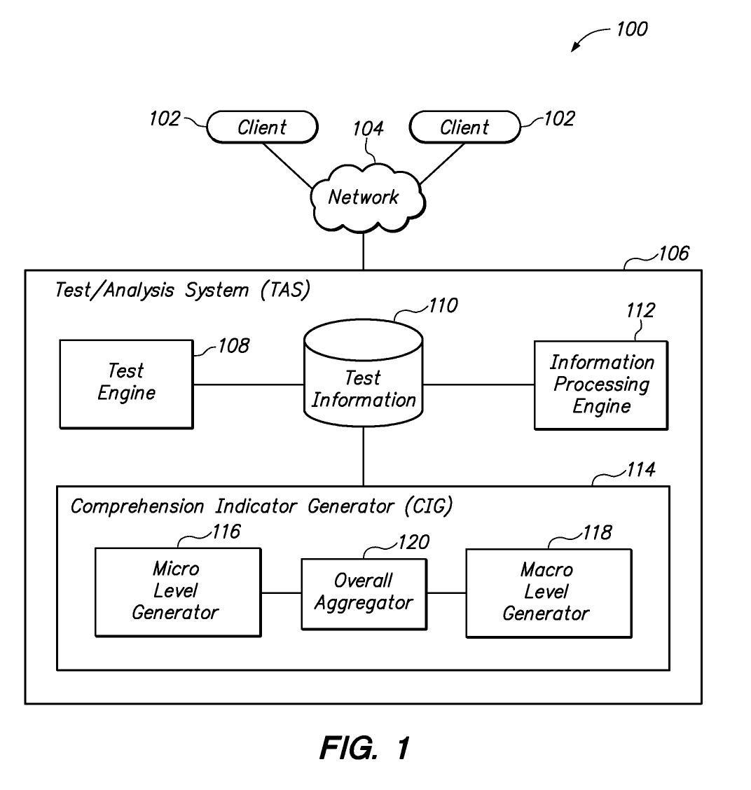

With reference to FIG. 1, there is shown a functional block diagram of a system 100 in which one embodiment of the present invention may be implemented. As shown, system 100 comprises a test/analysis system (TAS) 106, one or more clients 102, and a network 104 that communicatively couples the clients 102 to the TAS 106. For purposes of the present invention, the network 104 may be any type of network, including but not limited to a local area network (LAN), a wide area network (WAN) such as the Internet, an intranet, a wireless network, or any other type of interconnect that enables the clients 102 to communicate with the TAS 106. In system 100, the clients 102 represent devices or systems that are used by individuals (e.g. students, users, administrators, faculty members, educators, etc.) to interact with the TAS 106. The clients 102 may execute browsers or customized applications to enable them to interact with the TAS 106. For purposes of the present invention, the clients 102 may be any types of devices or systems, including but not limited to desktop computers, laptop computers, notebook computers, tablet computers, smart phones, etc.

In system 100, it is the TAS 106 that provides testing and analysis functionality to one or more individuals through the clients 102. In the embodiment shown, the TAS 106 takes the form of a computing system, and comprises a test engine 108, a data store 110, an information processing engine 112, and a comprehension indicator generator (CIG) 114. For the sake of illustration, these components 108, 110, 112, 114 are shown as being separate components. However, if so desired, these various components may be combined in various manners. For example, the information processing engine 112 may be incorporated into the test engine 108 or the CIG 114. Alternatively, the test engine 108, the information processing engine 112, and the CIG 114 may all be implemented as a single component. These and other combinations are possible, and all such combination are within the scope of the present invention. Also, the TAS 106 is shown in FIG. 1 as being implemented as a single computing system. If so desired, the TAS 106 may be implemented as separate computing systems. For example, the test engine 108, the information processing engine 112, and the CIG 114 may each be implemented on a separate computing system, or the test engine 108 and the information processing engine 112 may be implemented on one computing system while the CIG 114 is implemented on a separate computing system, or the test engine 108 may be implemented on one computing system while the information processing engine 112 and the CIG 114 are implemented on a separate computing system, etc. These and other system configurations are within the scope of the present invention.

### Test Engine and Data Store

In one embodiment, the test engine 108 is the component that administers tests to one or more individuals through one or more of the clients 102. In administering a test, the test engine 108 may use some of the test information stored in the data store 110. The test engine 108 may also store back into the data store 110 test information that results from administering a test.

In one embodiment, the data store 110 comprises information pertaining to each test that is administered by the test engine 108. For each test, the data store 110 may store, for example, a unique test identifier for the test, a course identifier that specifies the course with which the test is associated, one or more unique question identifiers that identify the test questions that are included in the test, as well as other information. With this information, the test engine 108 can quickly identify a test and quickly determine which questions are part of that test. In addition to this information, the data store 110 may also comprise information pertaining to the test questions themselves. The information pertaining to a test question may include, for example, a unique identifier for the test question, the actual content for the test question, the correct response for the test question, as well as one or more sets of metadata associated with the test question. The metadata associated with a test question may specify, for example, one or more concepts that are tested by the test question, a difficulty level for the test question, a question type (e.g. multiple choice, fill-in, etc.) for the test question, a point value for the test question, etc. The information for a test, and the information and metadata for each test question on the test, may be provided/specified by a creator (e.g. instructor, administrator, faculty member, etc.) of the test and test questions. Overall, in one embodiment, the data store 110 contains all of the test and test question information that the test engine 108 needs in order to administer one or more tests to one or more individuals.

To administer a test to an individual, the test engine 108 interacts with the individual through one of the clients 102. In one embodiment, as part of an initial interaction with the individual, the test engine 108 obtains a unique identifier for the individual (e.g. a student ID), and determines a test identifier and a course identifier for the test that the individual wishes to take. Using the test identifier and perhaps the course identifier, the test engine 108 accesses from the data store 110 the information pertaining to that test. From the accessed information, the test engine 108 determines which questions are on the test, and orders the questions into a list. The test engine 108 then presents the list to the individual via a user interface provided by the client 102. In one embodiment, in presenting the list of questions, the test engine 108 does not include the content of each question. Rather, the content of a test question is provided only when the individual selects the question from the list. Doing so makes it possible to know which question the individual has selected and hence, which question the individual is working on at any particular time. If so desired, certain metadata associated with a question may be shown on the list. For example, the point value associated with a question, the difficulty level of a question, and/or the concept(s) tested by a question may be shown next to the question on the list. That way, the individual can use this information to determine which question(s) he/she wishes to select.

As part of administering a test to an individual, the test engine 108 creates a test record. In one embodiment, this test record includes the identifier of the individual taking the test, the test identifier, and perhaps the identifier of the course. Also included in this test record may be information about the test questions on the test. For example, the test record may include, for each test question, the unique identifier for the test question, the actual content of the test question, the correct response for the test question, and the metadata associated with the test question. Having this test question information in the test record facilitates analysis of the test record, but it is redundant in that the same information is already stored in the data store 110. To avoid such redundancy, the test record may, if so desired, include just the identifier for each test question. The test record may also include the responses provided by the individual to the test questions. Furthermore, the test record may include behavioral information that indicates the test taking behavior of the individual while taking the test (this will be elaborated upon in a later section). Overall, the test record includes all of the information pertaining to the taking of the test by the individual. After the individual has completed taking the test (or while the individual is taking the test), the test engine 108 stores the test record into the data store 110 as part of the test information maintained by the data store 110. A test may be taken by a plurality of individuals (e.g. all of the individuals taking a course). Thus, the data store 110 may include a plurality of test records, one for each individual taking a particular test.

In one embodiment, while administering a test to an individual, the test engine 108 stores, in the test record for that individual, information pertaining to each interaction between the individual and the test. For example, the test engine 108 records the time at which the individual started the test and the time at which the individual completed the test. When the individual selects a test question, the test engine 108 records the time at which the test question was selected and the identifier for the test question. When the individual provides a response to a test question, the test engine 108 records the response and the time at which the response was provided. The individual may change his/her response to a question. If so, the test engine 108 records the new response and the time at which the new response was provided. When the individual stops working on a question and selects another question, the test engine 108 records the time at which the new test question was selected and the identifier for the new question. This and other information may be recorded by the test engine 108 and stored in the test record. Thus, in one embodiment, the test engine 108 records raw data that captures the details of the individual's actions while taking the test. When this raw data is processed/analyzed, a higher level understanding of the individual's test taking behavior can be derived.

### Information Processing Engine

In one embodiment, the information processing engine 112 processes the raw data in a test record to derive a higher level understanding of the test taking behavior of an individual for a particular test. Based on the raw data in a test record, the information processing engine 112 can make a number of higher level determinations. For example, the information processing engine 112 can determine how much time the individual spent on the overall test. This determination can be made, for example, based upon the time the individual started the test and the time the individual completed the test.

The information processing engine 112 can also determine how much time the individual spent on each test question. From the raw data, it is known when the individual selected each test question. Based on the time the individual selected a particular test question and the time the individual selected a next test question, it can be determined how much time the individual spent on the particular test question. The individual may have selected the particular test question several times during the test. By summing up all of the time segments from each time the individual selected the particular test question, the information processing engine 112 can determine how much total time the individual spent on the particular test question. This can be done for each test question on the test; thus, the information processing engine 112 can determine how much total time the individual spent on each test question.

The information processing engine 112 can also determine if, and how many times, the individual skipped each test question. From the raw data, it is known when the individual selected each test question. It is also known when the individual provided each response. Thus, if the raw data indicates that the individual selected a particular test question but did not provide a response to the particular test question before selecting a next test question, then the information processing engine 112 may conclude that the individual skipped the particular test question. Also, based upon the time the individual selected the particular test question and the time the individual selected the next test question, it can be determined how much time the individual spent on the particular test question before deciding to skip it. The individual may have selected the particular test question several times during the test. By making these determinations for each time the individual selected the particular test question, the information processing engine 112 can determine if, and how many times, the individual skipped the particular test question, and how much time the individual spent on the particular test question each time before deciding to skip it. This can be done for each test question on the test; thus, the information processing engine 112 can determine if, and how many times, the individual skipped each test question, and how much time the individual spent on each test question each time before deciding to skip it.

The information processing engine 112 can also determine if, and how many times, the individual changed his/her response to each test question. From the raw data, all of the responses (and their corresponding times of entry) for all of the test questions are known. If the raw data indicates that the individual provided a response to a particular test question at one time and then provided a different response to the same particular question at a subsequent time, then the information processing engine 112 may conclude that the individual changed his/her response to the particular test question. The individual may have selected the particular test question several times and may have provided several different responses. By analyzing all of the responses provided by the individual for the particular test question, the information processing engine 112 can determine if, and how many times, the individual changed his/her response to the particular test question. This can be done for each test question on the test; thus, the information processing engine 112 can determine if, and how many times, the individual changed his/her response to each test question.

The information processing engine 112 can also determine how many test questions the individual responded to in a last time segment of the test. The last time segment may be, for example, the last minute or last few minutes of the test. From the raw data, the time the individual completed the test is known. From the raw data, it is also known the time at which the individual provided each response to each test question. From this information, it can be determined how many responses were provided during a time segment (e.g. a minute or several minutes) immediately preceding the completion time of the test. The number of responses provided in the last time segment of the test may be significant because it may help to detect potential guessing. For example, if the individual provided many responses to test questions in the last minute of the test, then there is a likelihood that the individual guessed on at least some of those test questions.

The information processing engine 112 may process the raw data in a test record to make the above determinations as well as other determinations. These determinations may be viewed as summary information. From this summary information, a higher level understanding of the individual's behavior while taking the test can be gleaned. Once derived, the summary information may be stored in the test record. It should be noted that while storing the summary information in a test record may be desirable, it is not required. If so desired, the summary information may be stored elsewhere, or it may not be stored at all but rather may be generated from the raw data when needed. These and other implementations are within the scope of the present invention. In one embodiment, the raw data and the summary information in a test record make up a set of behavioral information that indicates the test taking behavior of an individual while taking a test. As an alternative, the set of behavioral information may include just the raw data or just the summary information.

In many if not most instances, a test will be taken by a plurality of individuals (e.g. all of the students in a particular course). Thus, the data store 110 may store a plurality of test records for a particular test, with each test record corresponding to a particular individual taking the particular test. In some circumstances, it may be desirable to derive some statistics across all of the individuals who have taken the particular test to have a basis for comparison. To accommodate such needs, the information processing engine 112 may generate, based upon the raw data and/or summary information for a plurality of individuals who have taken a particular test, a set of statistics that includes: (1) an average amount of time spent by the plurality of individuals on the overall test and a corresponding standard deviation; (2) an average amount of time spent by the plurality of individuals on each of the test questions on the test and a corresponding standard deviation; and (3) an average amount of time spent by the plurality of individuals on each test question prior to deciding to skip that test question. These and other statistics may be generated by the information processing engine 112. The information and statistics generated by the information processing engine 112 may be used to facilitate later processing and analysis.

### Comprehension Indicator Generator

After an individual has taken a test, a comprehension indicator that indicates how well the individual understood the subject matter covered by the test can be generated. In one embodiment, this is done by the comprehension indicator generator (CIG) 114. As shown in FIG. 1, the CIG 114, in one embodiment, comprises a micro level generator 116, a macro level generator 118, and an overall aggregator 120 (note: if so desired, the CIG 114 may comprise just the micro level generator 116 or just the macro level generator 118, in which case the overall aggregator 120 would not be needed). In one embodiment, to generate a comprehension indicator for an individual for a test, the CIG 114 accesses, from the data store 110, the test record corresponding to that individual for that test. The micro level generator 116 and the macro level generator 118 then use the information in the test record, including the behavioral information discussed previously, to generate a first test-level comprehension indicator and a second test-level comprehension indicator, respectively. The overall aggregator 120 then processes the first and second test-level comprehension indicators to derive an overall comprehension indicator for the individual for the test. In one embodiment, the processing and analysis performed by the information processing engine 112 (discussed above) are performed prior to the operation of the CIG 114; thus, the results of the processing and analysis are already in the test record and can be used by the micro level generator 116 and the macro level generator 118. Alternatively, the functionality of the information processing engine 112 may be incorporated into the CIG 114, and the processing and analysis may be performed when the CIG 114 is invoked. These and other possibilities are within the scope of the present invention.

In one embodiment, the micro level generator 116 generates a first test-level comprehension indicator based upon a plurality of question-level comprehension indicators. More specifically, in one embodiment, the micro level generator 116 generates a question-level comprehension indicator for each test question on the test. A question-level comprehension indicator, which indicates how well the individual understood the one or more concepts tested by a test question, may be generated based upon one or more question-level factors. These factors may include, for example, whether the individual answered the test question correctly, how much time the individual spent on the test question, whether and how many times the individual skipped the test question, whether and how many times the individual changed his/her response to the test question, the concept or concepts covered by the test question, the difficulty level of the test question, the type of the test question (e.g. multiple choice or fill-in), etc. As can be seen, as least some of these factors relate to the test taking behavior of the individual while taking the test. Information pertaining to the test taking behavior of the individual can be derived from the behavioral information discussed previously. In one embodiment, a question-level comprehension indicator takes the form of a numerical value between 1 and n, where n is an integer (e.g. 10, 100, etc.) (other ranges may be used if so desired), and the higher the value, the more it indicates that the individual understood the one or more concepts tested by the test question (alternatively, if so desired, the question-level comprehension indicator may be made such that the lower the value, the more it indicates that the individual understood the one or more concepts tested by the test question). After the question-level comprehension indicators are generated for all of the test questions, the micro level generator 116 generates a first test-level comprehension indicator based, at least in part, upon the question-level comprehension indicators. The micro level generator 116 may generate the first test-level comprehension indicator by, for example, computing an average or a weighted average of the question-level comprehension indicators. In one embodiment, the first test-level comprehension indicator also takes the form of a value between 1 and n. Once generated, the first test-level comprehension indicator is provided to the overall aggregator 120.

Like the micro level generator 116, the macro level generator 118 also generates a test-level comprehension indicator. However, rather than generating a test-level comprehension indicator based upon question-level factors, the macro level generator 118 generates a second test-level comprehension indicator based upon test-level factors. These factors may include, for example, how much time the individual spent on the entire test, whether the responses provided by the individual form certain discernable patterns (e.g. ccccc or abcdabcd, etc.) that may indicate guessing, whether the individual targeted questions with certain point values, how well the individual performed on specific concepts covered by the test, how many questions the individual answered in a last time segment of the test, etc. In one embodiment, the second test-level comprehension indicator also takes the form of a value between 1 and n. Once generated, the second test-level comprehension indicator is provided to the overall aggregator 120.

Given the first and second test-level comprehension indicators, the overall aggregator 120 proceeds to generate an overall comprehension indicator that indicates how well the individual understood the subject matter covered by the test. In one embodiment, the overall aggregator 120 generates the overall comprehension indicator as an average or a weighted average of the first and second test-level comprehension indicators. In one embodiment, the overall comprehension indicator also takes the form of a value between 1 and n.

The above provides a high level description of the CIG 114. In the sections that follow, the micro level generator 116 and the macro level generator 118 will be described in greater detail.

### Micro Level Generator

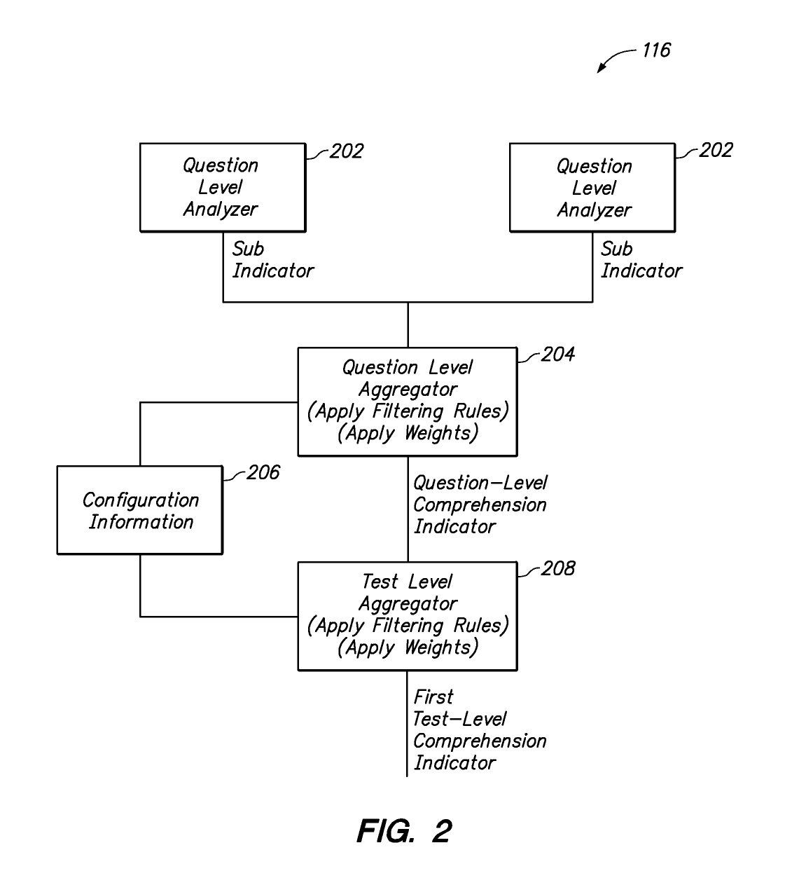

FIG. 2 shows a functional block diagram depicting the micro level generator 116 in greater detail, in accordance with one embodiment of the present invention. As shown in FIG. 2, the micro level generator 116 comprises one or more question level analyzers 202, a question level aggregator 204, and a test level aggregator 208.

In one embodiment, each question level analyzer 202 analyzes one or more specific aspects pertaining to a test question, and generates a sub indicator based upon that analysis. The sub indicator provided by a question level analyzer 202 indicates how well the individual understood the subject matter tested by a test question based upon the one or more specific aspects of the test question considered by the question level analyzer 202. For purposes of the present invention, a question level analyzer 202 may take into account any specific aspect(s) of a test question. As examples, one question level analyzer 202 may take into account the amount of time spent by the individual on the test question, while another question level analyzer 202 may take into account whether and how many times a test question was skipped by the individual, while another question level analyzer 202 may take into account whether and how many times the individual changed his/her response to a test question, etc. Specific examples of question level analyzers 202 will be provided in later sections, but suffice it to say at this point that each question level analyzer 202 analyzes one or more specific aspects pertaining to a test question, and provides a sub indicator as a result of that analysis. In one embodiment, the sub indicator provided by a question level analyzer 202 takes the form of a value between 1 and n.

The sub indicators provided by the question level analyzers 202 for a test question are received by the question level aggregator 204. Upon receiving the sub indicators, the question level aggregator 204 may apply one or more filtering rules. In one embodiment, the filtering rules may be obtained from a set of configuration information 206, which may be specified by an educator, an administrator, a faculty member, or some other person or entity. The filtering rules may be used to filter out or eliminate one or more of the sub indicators. This may be desirable because in some circumstances, the sub indicator from one or more of the question level analyzers 202 may not be relevant. The question level aggregator 204 may also apply different weights to different sub indicators. Like the filtering rules, these weights may be obtained from the configuration information 206. Giving different weights to different sub indicators may be desirable because, for different circumstances and different tests, some sub indicators may be more important than others. After applying the filtering rules (if any) and weights (if any) to the sub indicators, the question level aggregator 204 generates a question-level comprehension indicator for the test question. The question level aggregator 204 may do so, for example, by averaging the various sub indicator values. In the case where different weights have been applied to different sub indicators, the question level aggregator 204 may derive a weighted average from the weights and the sub indicators. These and other methodologies may be used to generate the question-level comprehension indicator for the test question. In one embodiment, the question-level comprehension indicator takes the form of a value between 1 and n. Once generated, the question-level comprehension indicator is provided to the test level aggregator 208.

In one embodiment, the question level analyzers 202 and the question level aggregator 204 operate on each test question of a test. Thus, in operation, the micro level generator 116 selects one of the test questions on the test. The question level analyzers 202 then perform analysis on the selected test question, and provide sub indicators for that test question to the question level aggregator 204. In turn, the question level aggregator 204 uses the sub indicators (and perhaps some filtering rules and weights) to generate a question-level comprehension indicator for the selected test question, and provides the question-level comprehension indicator to the test level aggregator 208. The micro level generator 116 then selects another test question, and the operation of the question level analyzers 202 and the question level aggregator 204 described above is repeated. By the time all of the test questions have been selected by the micro level generator 116, the test level aggregator 208 will have received a question-level comprehension indicator for each of the test questions on the test. (Note: In the embodiment described, it is assumed that a question-level comprehension indicator is generated for each of the test questions on the test. This is not required. If so desired, a question-level comprehension indicator may be generated for just a subset of the test questions. This and other modifications are within the scope of the present invention).

Having received the question-level comprehension indicators for all of the test questions on the test, the test level aggregator 208 may apply one or more filtering rules. These filtering rules may be obtained from the configuration information 206. The filtering rules may be used to filter out or eliminate one or more of the question-level comprehension indicators. This may be desirable because there may be some test questions that are not relevant for purposes of determining how well the individual understood the subject matter covered by the test. The test level aggregator 208 may also apply different weights to different question-level comprehension indicators. Like the filtering rules, these weights may be obtained from the configuration information 206. Giving different weights to different question-level comprehension indicators may be desirable because, for different circumstances and different tests, some test questions may be more important than others for purposes of determining how well the individual understood the subject matter covered by the test. After applying the filtering rules (if any) and weights (if any) to the question-level comprehension indicators, the test level aggregator 208 generates a first test-level comprehension indicator. The test level aggregator 208 may do so, for example, by averaging the various question-level comprehension indicator values. In the case where different weights have been applied to different question-level comprehension indicators, the test level aggregator 208 may derive a weighted average based at least in part upon the weights and the question-level comprehension indicators. These and other methodologies may be used to generate the first test-level comprehension indicator for the test. In one embodiment, the first test-level comprehension indicator takes the form of a value between 1 and n. Once generated, the first test-level comprehension indicator is provided to the overall aggregator 120 shown in FIG. 1.

In the above description, the question level analyzers 202 are discussed at a fairly general level. In the following sections, specific examples of question level analyzers 202 will be provided for illustrative purposes.

### Time Analyzer

One analyzer that may be included as one of the question level analyzers 202 is a time analyzer. In one embodiment, this analyzer generates a sub indicator for a test question based, at least in part, upon how much time the individual spent on the test question. To generate this sub indicator, the time analyzer, in one embodiment, determines how much time the individual spent on the test question, and how much time was spent, on average, by a plurality of individuals on that same test question. These sets of information may be derived from the behavioral information discussed above and from the statistics generated by the information processing engine 112. The time analyzer compares the amount of time spent by the individual with the average amount of time spent by the plurality of individuals. In one embodiment, if the amount of time spent by the individual is relatively close to the average, then the analyzer may assign a relatively high value to the sub indicator for the test question (thereby indicating a fairly high level of comprehension of the one or more concepts tested by the test question). On the other hand, if the amount of time spent by the individual is significantly different from the average, then the analyzer may assign a lower value to the sub indicator for the test question. In one embodiment, the more the amount of time spent by the individual deviates from the average, the lower the value assigned to the sub indicator. The rationale for this is that if the individual spent significantly more time than the average, then perhaps the individual did not understand the one or more concepts tested by the test question as well as the other individuals. If the individual spent significantly less time than the average, then perhaps the individual did not really answer the question but rather may have guessed. In either case, the analyzer provides a lower sub indicator to indicate a lower comprehension of the one or more concepts tested by the test question.

### Question Skip Analyzer

Another analyzer that may be included as one of the question level analyzers 202 is a question skip analyzer. In one embodiment, this analyzer generates a sub indicator for a test question based, at least in part, upon how many times the individual skipped the test question and how much time the individual spent on the test question each time he/she skipped it. To generate this sub indicator, the question skip analyzer, in one embodiment, determines how many times the individual skipped the test question, how much time the individual spent on the test question each time he/she skipped it, and how much time was spent, on average, by a plurality of individuals on that same test question when they decided to skip it. These sets of information may be derived from the behavioral information discussed above and from the statistics generated by the information processing engine 112.

In one embodiment, the analyzer first takes into account how many times the individual skipped the test question. If the individual did not skip the test question, then the analyzer may assign a relatively high value to a times-skipped indicator. In one embodiment, the times-skipped indicator takes the form of a value between 1 and n. The more times the individual skipped the test question, the lower the value assigned to the times-skipped indicator. The rationale is that the more times the individual skipped the test question, the less he/she comprehended the one or more concepts tested by the test question.

The analyzer also takes into account how much time the individual spent on the test question each time he/she skipped it. For each time the individual skipped the test question, the analyzer compares the amount of time spent by the individual on the test question before skipping it with the average amount of time spent by the plurality of individuals on the test question before skipping it. In one embodiment, if the amount of time spent by the individual is relatively close to the average, then the analyzer may assign a relatively high value to a time-spent indicator. In one embodiment, the time-spent indicator takes the form of a value between 1 and n. On the other hand, if the amount of time spent by the individual is significantly different from the average, then the analyzer may assign a lower value to the time-spent indicator. The more the amount of time spent by the individual deviates from the average, the lower the value assigned to the time-spent indicator. In one embodiment, a time-spent indicator is generated for each time the individual skipped the test question; thus, if the individual skipped the test question multiple times, then multiple time-spent indicators may be generated.

After generating the times-skipped indicator and the time-spent indicator(s), the analyzer proceeds to generate a sub indicator for the test question. The analyzer may generate the sub indicator by, for example, computing an average or a weighted average of the times-skipped indicator and the time-spent indicator(s).

### Response Change Analyzer

Another analyzer that may be included as one of the question level analyzers 202 is a response change analyzer. In one embodiment, this analyzer generates a sub indicator for a test question based, at least in part, upon how many times the individual changed his/her response to the test question. The number of times the individual changed his/her response to the test question can be derived from the behavioral information discussed above. In one embodiment, if the individual did not change his/her response to the test question, then the analyzer may assign a relatively high value to the sub indicator for the test question. The more times the individual changed his/her response to the test question, the lower the value assigned to the sub indicator for the test question. The rationale is that the more times the individual changed his/her response, the less he/she comprehended the one or more concepts tested by the test question.

### Single Concept Analyzer

Another analyzer that may be included as one of the question level analyzers 202 is a single concept analyzer. This analyzer may be applied to test questions that test a single concept. The concept tested by a test question may be determined from the metadata for that test question.

In one embodiment, for a particular test question that tests a particular concept, this analyzer generates a sub indicator for the particular test question by generating and processing a percentage-correct indicator and a points indicator.

In one embodiment, to generate the percentage-correct indicator, the analyzer determines whether the individual answered the particular test question correctly. The analyzer further determines which other test questions on the test also test only the particular concept, and whether the individual answered those test questions correctly. The analyzer then determines what percentage of the test questions that test only the particular concept the individual answered correctly. This percentage is then used to generate the percentage-correct indicator. In one embodiment, the percentage-correct indicator takes the form of a value between 1 and n, and the higher the percentage, the higher the value that is assigned to the percentage-correct indicator.

The analyzer also generates a points indicator. To generate this indicator, the analyzer, in one embodiment, determines the point value assigned to the particular test question and the point value assigned to each of the other test questions on the test that test only the particular concept (the point value for each test question may be determined from the metadata for that test question). Based on which of these test questions the individual answered correctly and their corresponding point values, the analyzer determines how many points were earned by the individual on these test questions. The analyzer then compares this point total against an average point total earned by a plurality of individuals on the same test questions on the same test (the analyzer may determine the average point total by processing the test records of a plurality of individuals who have taken the same test). Based upon this comparison, the analyzer generates the points indicator. More specifically, the more the point total of the individual deviates from the average point total to the upside, the higher the value assigned to the points indicator. The more the point total of the individual deviates from the average point total to the downside, the lower the value assigned to the points indicator. In one embodiment, the points indicator takes the form of a value between 1 and n.

After generating the percentage-correct indicator and the points indicator, the analyzer proceeds to generate a sub indicator for the particular test question. The analyzer may generate the sub indicator by, for example, computing an average or a weighted average of the percentage-correct indicator and the points indicator.

### Multi-Concept Analyzer

Some test questions may test multiple concepts. Thus, another analyzer that may be included as one of the question level analyzers 202 is a multi-concept analyzer. This analyzer may be applied to test questions that test multiple concepts.

In one embodiment, for a particular test question that tests multiple concepts, this analyzer generates a proficiency indicator for each of the concepts tested by the particular question. In particular, for a first concept tested by the particular question, the analyzer determines which other test questions on the test test only the first concept, and whether the individual answered those test questions correctly. The analyzer then determines what percentage of those test questions the individual answered correctly. (For example, suppose the first concept is concept X, and that there are four test questions on the test that test only concept X. If the individual answered three of those test questions correctly, then the percentage would 75%). This percentage is then used to generate the proficiency indicator for the first concept. In one embodiment, the proficiency indicator takes the form of a value between 1 and n, and the higher the percentage, the higher the value that is assigned to the proficiency indicator. The analyzer performs the above operations for each of the concepts tested by the particular question. Thus, the analyzer will generate a proficiency indicator for each of the tested concepts.

After generating the proficiency indicators for all of the tested concepts, the analyzer proceeds to generate a sub indicator for the particular test question. The analyzer may generate the sub indicator by, for example, computing an average or a weighted average of the proficiency indicators.

### Difficulty Level Analyzer

Another analyzer that may be included as one of the question level analyzers 202 is a difficulty level analyzer. In one embodiment, this analyzer generates a sub indicator for a test question based at least in part upon the difficulty level of the test question and the concept tested by the test question. The difficulty level and the concept tested may be determined from the metadata for the test question.

In one embodiment, for a test question that has a particular difficulty level and that tests a particular concept, this analyzer determines whether the individual answered that test question correctly. The analyzer further determines which other test questions on the test also test only the particular concept and have the same particular difficulty level, and whether the individual answered those test questions correctly. The analyzer then determines what percentage of the test questions that test only the particular concept and that have the particular difficulty level the individual answered correctly. This percentage is then used by the analyzer to generate a sub indicator for the test question. In one embodiment, the higher the percentage, the higher the value that is assigned to the sub indicator for the test question.

### Question Type Analyzer

Another analyzer that may be included as one of the question level analyzers 202 is a question type analyzer. In one embodiment, this analyzer generates a sub indicator for a test question based at least in part upon the question type of the test question.

A test question may be one of several different types. For example, a test question may be a multiple choice question or a fill-in question that requires the individual to fill in the answer. Since it is much more difficult to correctly guess the answer to a fill-in question, it makes sense to accord this type of question greater weight. In one embodiment, the question type analyzer takes the type of question into account in generating a sub indicator for a test question.

To generate a sub indicator for a particular test question, the analyzer determines the question type of the particular test question (the question type may be determined from the metadata for the particular test question), and whether the individual answered the particular test question correctly. In one embodiment, the analyzer further determines whether one or more other test questions on the test are substantively similar or identical to the particular test question. The metadata for a test question may be augmented to include information that indicates substantive similarity between test questions. Thus, the analyzer may use this information in determining whether there are other test questions that are substantively similar to the particular test question. If a substantively similar test question is found, then the analyzer determines the question type of the substantively similar test question and whether the individual answered the substantively similar test question correctly. Based at least in part upon these determinations, the analyzer generates a sub indicator for the particular test question.

For example, suppose the particular test question is a multiple choice question and the substantively similar test question is a fill in question. Suppose further that the individual answered the particular test question correctly but answered the substantively similar test question incorrectly. In such a case, the analyzer may assign a relatively low value to the sub indicator for the particular question, despite the fact that the individual answered the particular test question correctly. The rationale is that, since the individual answered the substantively similar test question (which is a fill in question) incorrectly, the individual probably did not understand the concept or concepts being tested by the test questions. The individual may have answered the particular test question (which is a multiple choice question) correctly simply as a result of a lucky guess. Thus, relatively little weight is given to the correct answering of the particular test question.

Suppose instead that the particular test question is a fill in question and the substantively similar test question is a multiple choice question. Suppose further that the individual answered the particular test question correctly but answered the substantively similar test question incorrectly. In such a case, the analyzer may assign a relatively high value to the sub indicator for the particular test question, even though the individual answered the substantively similar test question incorrectly. The rationale is that, since the individual answered the particular test question (which is a fill in question) correctly, it is highly likely that the individual understood the concept or concepts being tested by the test question. The individual may have just made a human mistake and accidentally selected the wrong answer for the substantively similar test question (which is a multiple choice question). Thus, relatively little weight is given to the incorrect answering of the substantively similar question.

If the individual answered both test questions correctly, then the analyzer may assign a relatively high value to the sub indicator for the particular test question, and if the individual answered both test questions incorrectly, then the analyzer may assign a relatively low value to the sub indicator for the particular test question. In this manner, the question type analyzer generates a sub indicator for a particular test question based at least in part upon the question type of the particular test question.

One or more of the example analyzers described above may be included in the question level analyzers 202 of the micro level generator 116. Other analyzers may be included as well. Thus, for purposes of the present invention, any of the disclosed analyzers, as well as any other analyzers that are not disclosed, may be included in the question level analyzers 202 of the micro level generator 116 in any desired combination.

### Macro Level Generator

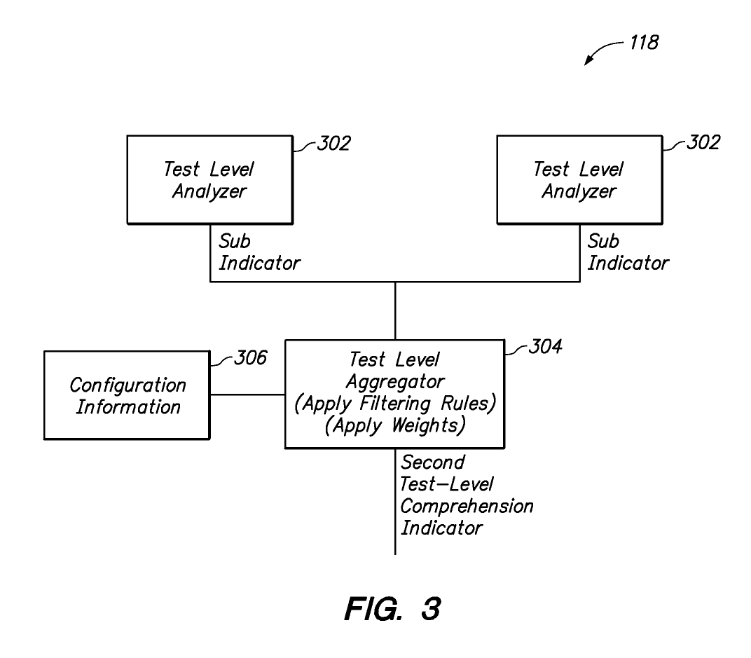

FIG. 3 shows a functional block diagram depicting the macro level generator 118 of FIG. 1 in greater detail, in accordance with one embodiment of the present invention. As shown in FIG. 3, the macro level generator 118 comprises one or more test level analyzers 302 and a test level aggregator 304.

In one embodiment, each test level analyzer 302 analyzes one or more specific aspects pertaining to a test, and generates one or more sub indicators based upon that analysis. The sub indicator provided by a test level analyzer 302 indicates how well an individual understood the subject matter covered by the test based upon the one or more specific aspects of the test considered by the test level analyzer 302. For purposes of the present invention, a test level analyzer 302 may take into account any specific aspect(s) of a test. As examples, one test level analyzer 302 may take into account the amount of time spent by the individual on the overall test, while another test level analyzer 302 may take into account response patterns that may be exhibited in the responses provided by the individual that may indicate guessing, while another test level analyzer 302 may take into account how many responses were provided by the individual in a last time segment of the test, etc. Specific examples of test level analyzers 302 will be provided in later sections, but suffice it to say at this point that each test level analyzer 302 analyzes one or more specific aspects pertaining to a test, and provides a sub indicator as a result of that analysis. In one embodiment, the sub indicator provided by a test level analyzer 302 takes the form of a value between 1 and n.

The sub indicators provided by the test level analyzers 302 for a test are received by the test level aggregator 304. Upon receiving the sub indicators, the test level aggregator 304 may apply one or more filtering rules. In one embodiment, the filtering rules may be obtained from a set of configuration information 306, which may be specified by an educator, an administrator, a faculty member, or some other person or entity. The filtering rules may be used to filter out or eliminate one or more of the sub indicators. This may be desirable because in some circumstances, the sub indicator from one or more of the test level analyzers 302 may not be relevant. The test level aggregator 304 may also apply different weights to different sub indicators. Like the filtering rules, these weights may be obtained from the configuration information 306. Giving different weights to different sub indicators may be desirable because for different circumstances and different tests, some sub indicators may be more important than others. After applying the filtering rules (if any) and weights (if any) to the sub indicators, the test level aggregator 304 generates a second test-level comprehension indicator for the test. The test level aggregator 304 may do so, for example, by averaging the various sub indicator values. In the case where different weights have been applied to different sub indicators, the test level aggregator 304 may derive a weighted average from the weights and the sub indicators. These and other methodologies may be used to generate the second test-level comprehension indicator for the test. In one embodiment, the second test-level comprehension indicator takes the form of a value between 1 and n. Once generated, the second test-level comprehension indicator is provided to the overall aggregator 120 shown in FIG. 1.

In the above description, the test level analyzers 302 are discussed at a fairly general level. In the following sections, specific examples of test level analyzers 302 will be provided for illustrative purposes.

### Overall Time Analyzer

One analyzer that may be included as one of the test level analyzers 202 is an overall time analyzer. In one embodiment, this analyzer generates a sub indicator for a test based, at least in part, upon how much time the individual spent on the overall test. To generate this sub indicator, the overall time analyzer, in one embodiment, determines how much time the individual spent on the overall test, and how much time was spent, on average, by a plurality of individuals on the overall test. These sets of information may be derived from the behavioral information discussed above and from the statistics generated by the information processing engine 112. The overall time analyzer compares the amount of time spent by the individual with the average amount of time spent by the plurality of individuals. In one embodiment, if the amount of time spent by the individual is relatively close to the average, then the analyzer may assign a relatively high value to the sub indicator provided by the analyzer (thereby indicating a fairly high level of comprehension of the subject matter covered by the test). On the other hand, if the amount of time spent by the individual is significantly different from the average, then the analyzer may assign a lower value to the sub indicator. In one embodiment, the more the amount of time spent by the individual deviates from the average, the lower the value assigned to the sub indicator. The rationale for this is that if the individual spent significantly more time than the average, then perhaps the individual did not understand the subject matter covered by the test as well as the other individuals. If the individual spent significantly less time than the average, then perhaps the individual did not really attempt to answer the questions but rather may have guessed on a number of the questions. In either case, the analyzer outputs a lower sub indicator to indicate a lower comprehension of the subject matter covered by the test.

### Response Pattern Analyzer

Another analyzer that may be included as one of the test level analyzers 302 is a response pattern analyzer. In one embodiment, this analyzer attempts to detect potential guessing by the individual. It has been observed that when test takers guess on a test, they tend to guess in certain patterns. For example, for test questions on which they guess, test takers may answer with all c's, all d's, etc. They may also use other patterns, such as alternating patterns like abcd on consecutive questions. By looking for these and other discernable patterns in the individual's responses, this analyzer attempts to detect potential guessing by the individual.

In one embodiment, to do so, the analyzer first checks for certain patterns. For example, the analyzer may check for consecutive responses with the same answer (e.g. ccccc, dddd, etc.). The consecutive string of responses may be of any length (e.g. 5, 8, 10, etc. responses in a row). The analyzer may also check for alternating patterns, which may repeat (e.g. abcd, abcdabcd, etc.). These and other patterns may be detected by the analyzer. In one embodiment, if a pattern is detected, the analyzer delves further to determine whether a majority of the responses in the pattern are correct. It is possible, for example, that the correct answers for several consecutive questions may be cccc. If a pattern of ccccc is found but the correct answer for four of those questions was c, then it may not be proper to conclude that any guessing took place. Thus, the analyzer takes the correctness of the responses into account. In one embodiment, if the analyzer does not detect any discernable patterns in the individual's responses, then the analyzer may assign a higher value to the sub indicator provided by the analyzer. On the other hand, if the analyzer detects one or more discernable patterns in the individual's responses and if a majority of the responses in the one or more discernable patterns are incorrect, then the analyzer may assign a lower value to the sub indicator (thereby indicating a likelihood of guessing, and hence, a lower comprehension of the subject matter covered by the test).

### Concept Analyzer

Another analyzer that may be included as one of the test level analyzers 302 is a concept analyzer. In one embodiment, this analyzer generates a sub indicator for each concept that is covered by the test. In one embodiment, this analyzer determines, from the metadata for each of the test questions, the concept tested by each test question. By doing so, the analyzer determines all of the concepts that are covered by the overall test. For each of these concepts, the analyzer determines which test questions test that concept. The analyzer then determines what percentage of those test questions the individual answered correctly. Based on that percentage, the analyzer generates a sub indicator for that concept. In one embodiment, the higher the percentage, the higher the value assigned to the sub indicator.

For example, suppose that a test has ten test questions and that questions 1-5 test concept X and questions 6-10 test concept Y. For such a test, the concept analyzer, in one embodiment, would generate a sub indicator for concept X and a sub indicator for concept Y. The sub indicator for concept X would be generated based at least in part upon the percentage of questions 1-5 that the individual answered correctly, and the sub indicator for concept Y would be generated based at least in part upon the percentage of questions 6-10 that the individual answered correctly.

Once generated, the sub indicator for each of the concepts covered by the test is provided to the test level aggregator 304.

### Points Analyzer

Another analyzer that may be included as one of the test level analyzers 302 is a points analyzer. In one embodiment, this analyzer generates a sub indicator based at least in part upon whether the individual targeted test questions with certain point values.

To try and pass a test with minimum effort, an individual may specifically target test questions with higher point values and spend most of his/her time on those test questions. Students who take this approach often do not have a high level of comprehension of the subject matter covered by a test. In one embodiment, the points analyzer attempts to detect this pattern of behavior. To do so, the analyzer uses the information in the behavioral information discussed previously and the metadata associated with each test question. Specifically, from the behavioral information, it is known when the individual selected each test question. From the metadata, it is known what point value is assigned to each test question. From these sets of information, it is possible to determined the sequence in which the individual selected the test questions, and whether the individual targeted test questions with higher point values.

In one embodiment, if the individual did not specifically target test questions with higher point values, then the points analyzer assigns a higher value to the sub indicator provided by the analyzer. However, if the individual did specifically target test questions with higher point values, then the points analyzer delves deeper to determine whether the individual answered the higher point questions correctly. If the individual answered a relatively high percentage of the high point value questions correctly, then the analyzer may assign a higher value to the sub indicator provided by the analyzer. If the individual answered a relatively low percentage of the high point value questions correctly, then the analyzer may assign a lower value to the sub indicator provided by the analyzer. In one embodiment, the higher the percentage, the high the value assigned to the sub indicator, and the lower the percentage, the lower the value assigned to the sub indicator.

### Last Responses Analyzer

Another analyzer that may be included as one of the test level analyzers 302 is a last responses analyzer. In one embodiment, this analyzer takes into account the number of responses provided by the individual in a last time segment (e.g. minute, several minutes, etc.) of the test. The significance of this aspect is that the more responses to test questions the individual provided in the last time segment of the test, the more likely it is that the individual guessed on at least some of those test questions.

As discussed previously, it is possible to determine from the behavioral information how many responses were provided by the individual in a last time segment of the test. Based at least in part upon this number of responses, the last responses analyzer may generate a sub indicator. In one embodiment, if the number of responses is relatively low, then a higher value may be assigned to the sub indicator. On the other hand, if the number of response is relatively high, then a lower value may be assigned to the sub indicator. In general, the higher the number of responses, the lower the value assigned to the sub indicator.

One or more of the example analyzers described above may be included in the test level analyzers 302 of the macro level generator 118. Other analyzers may be included as well. Thus, for purposes of the present invention, any of the disclosed analyzers, as well as any other analyzers that are not disclosed, may be included in the test level analyzers 302 of the micro level generator 118 in any desired combination.

### Hardware Overview

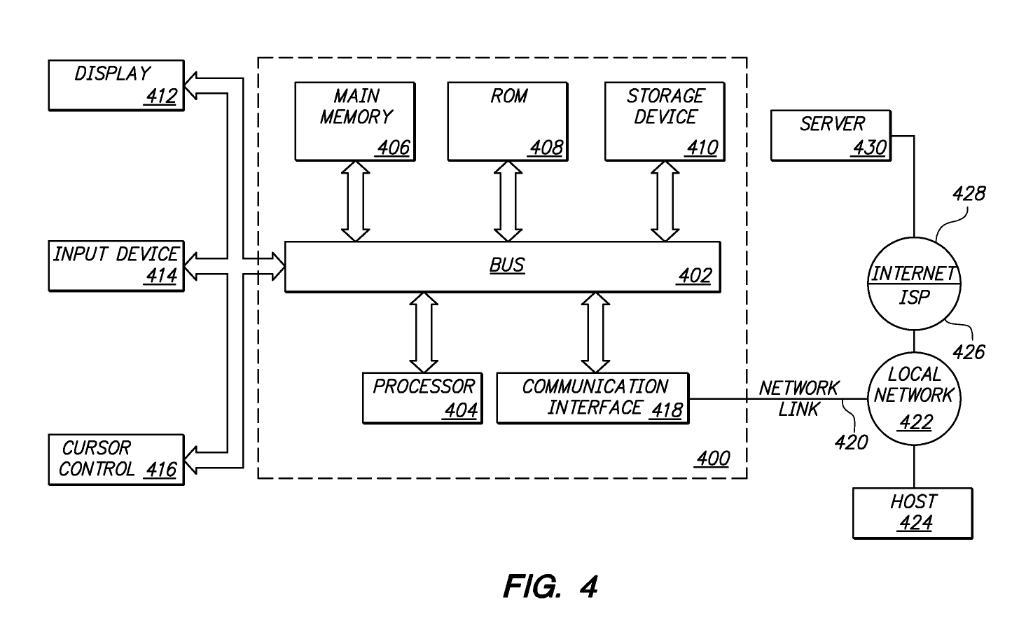

With reference to FIG. 4, there is shown a block diagram of a computer system that may be used to implement the TAS 106 and one or more of the clients 102 shown in FIG. 1. Computer system 400 includes a bus 402 or other communication mechanism for communicating information, and one or more hardware processors 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques and components (e.g. test engine 108, data store 110, information processing engine 112, CIG 114, micro level generator 116, macro level generator 118, overall aggregator 120, question level analyzers 202, aggregators 204, 208, test level analyzers 302, aggregator 304, etc.) described herein using customized hard-wired logic, one or more ASICs or FPGAs, firmware and/or program logic which in combination with the computer system causes or programs computer system 400 to be a special-purpose machine. According to one embodiment, the techniques disclosed herein for test engine 108, data store 110, information processing engine 112, CIG 114, micro level generator 116, macro level generator 118, overall aggregator 120, question level analyzers 202, aggregators 204, 208, test level analyzers 302, aggregator 304, etc., are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418. The received code may be executed by processor 404 as it is received, and/or stored in storage device 410, or other non-volatile storage for later execution.

At this point, it should be noted that although the invention has been described with reference to specific embodiments, it should not be construed to be so limited. Various modifications may be made by those of ordinary skill in the art with the benefit of this disclosure without departing from the spirit of the invention. Thus, the invention should not be limited by the specific embodiments used to illustrate it but only by the scope of the issued claims.

What is claimed is:

1. A method comprising:
accessing a set of test information pertaining to a test, wherein the test comprises a plurality of test questions and has been taken by at least a particular individual, and wherein the test information comprises responses provided by the particular individual to the test questions and behavioral information that indicates test taking behavior of the particular individual while taking the test;
for each test question in at least a subset of the plurality of test questions, generating a question-level comprehension indicator for the test question that indicates how well the particular individual understood one or more concepts tested by the test question, wherein the question-level comprehension indicator for the test question is generated based, at least in part, upon the behavioral information, and wherein a question-level comprehension indicator is generated for each of the test questions in the at least a subset of test questions, thereby giving rise to a plurality of question-level comprehension indicators; and
generating, based at least in part upon the plurality of question-level comprehension indicators, a first test-level comprehension indicator for the test, which indicates how well the particular individual understood subject matter covered by the test;
wherein the method is performed by one or more computing devices or systems.

2. The method of claim 1, wherein the behavioral information indicates how much time was spent by the particular individual on each test question, and wherein generating a question-level comprehension indicator for each test question in at least a subset of the plurality of test questions comprises:
selecting a particular test question;
determining an amount of time spent by the particular individual on the particular test question; and
generating a question-level comprehension indicator for the particular test question based at least in part upon the amount of time spent by the particular individual on the particular test question.

3. The method of claim 2, wherein generating a question-level comprehension indicator for the particular test question based at least in part upon the amount of time spent by the particular individual on the particular test question comprises:
determining how the amount of time spent by the particular individual on the particular test question compares to an average amount of time spent by other individuals on the particular test question.

4. The method of claim 1, wherein the behavioral information indicates how many times the particular individual skipped any of the test questions, and wherein generating a question-level comprehension indicator for each test question in at least a subset of the plurality of test questions comprises:
selecting a particular test question;
determining how many times the particular individual skipped the particular test question; and
generating a question-level comprehension indicator for the particular test question based at least in part upon how many times the particular individual skipped the particular test question.

5. The method of claim 1, wherein the behavioral information indicates how many times the particular individual skipped each test question and how much time was spent by the particular individual on a skipped test question each time the particular individual decided to skip a skipped test question, and wherein generating a question-level comprehension indicator for each test question in at least a subset of the plurality of test questions comprises:
selecting a particular test question;
determining how many times the particular individual skipped the particular test question and how much time the particular individual spent on the particular test question each time the particular question was skipped; and
generating a question-level comprehension indicator for the particular test question based at least in part upon how many times the particular individual skipped the particular test question and how much time the particular individual spent on the particular test question each time the particular question was skipped.

6. The method of claim 1, wherein the behavioral information indicates how many times the particular individual changed his/her response to each test question, and wherein generating a question-level comprehension indicator for each test question in at least a subset of the plurality of test questions comprises:
selecting a particular test question;
determining how many times the particular individual changed his/her response to the particular test question; and
generating a question-level comprehension indicator for the particular test question based at least in part upon how many times the particular individual changed his/her response to the particular test question.

7. The method of claim 1, wherein the test data further comprises metadata for each test question that specifies one or more concepts tested by each test question, and wherein generating a question-level comprehension indicator for each test question in at least a subset of the plurality of test questions comprises:
selecting a particular test question;
determining that a particular concept is being tested by the particular test question;
determining which other test questions are testing the particular concept;
determining a percentage of all test questions that test the particular concept that the particular individual answered correctly; and
generating a question-level comprehension indicator for the particular test question based at least in part upon the percentage of all test questions that test the particular concept that the particular individual answered correctly.

8. The method of claim 1, wherein the test data further comprises metadata for each test question, wherein the metadata specifies how many points are allocated to each test question and further specifies one or more concepts tested by each test question, and wherein generating a question-level comprehension indicator for each test question in at least a subset of the plurality of test questions comprises:
selecting a particular test question;
determining that a particular concept is being tested by the particular test question;
determining which other test questions are testing the particular concept;
determining which test questions that test the particular concept the particular individual answered correctly;
determining an amount of points earned by the particular individual for correctly answering the test questions that test the particular concept;
comparing the amount of points earned by the particular individual with an average amount of points earned by other individuals for the test questions that test the particular concept and
generating a question-level comprehension indicator for the particular test question based at least in part upon the comparison of the amount of points earned by the particular individual with the average amount of points earned by other individuals for the test questions that test the particular concept.

9. The method of claim 1, wherein the test data further comprises metadata for each test question, wherein the metadata specifies one or more concepts tested by each test question and further specifies a difficultly level for each test question, and wherein generating a question-level comprehension indicator for each test question in at least a subset of the plurality of test questions comprises:
selecting a particular test question;
determining that a particular concept is being tested by the particular test question;
determining that the particular test question is of a particular difficulty level;
determining a particular set of test questions that test the particular concept and that are of the particular difficulty level;
determining a percentage of the particular set of test questions that the particular individual answered correctly; and
generating a question-level comprehension indicator for the particular test question based at least in part upon the percentage of the particular set of test questions that the particular individual answered correctly.

10. The method of claim 1, wherein the test data further comprises metadata for each test question that specifies a question type for each test question, wherein the question type of a test question is one of a set comprising multiple choice and fill-in, and wherein generating a question-level comprehension indicator for each test question in at least a subset of the plurality of test questions comprises:
selecting a particular test question;
determining a question type for the particular test question; and
generating a question-level comprehension indicator for the particular test question based at least in part upon the question type for the particular question.

11. The method of claim 1, wherein generating a question-level comprehension indicator for each test question in at least a subset of the plurality of test questions comprises:
selecting a particular test question;
generating, for the particular test question, a plurality of sub indicators; and
generating a question-level comprehension indicator for the particular test question based at least in part upon the plurality of sub indicators.

12. The method of claim 11, wherein at least some of the plurality of sub indicators are generated based, at least in part, upon the behavioral information.

13. The method of claim 1, further comprising:
based at least in part upon an analysis of the test information from a macro level, generating a second test-level comprehension indicator for the test, which indicates how well the particular individual understood subject matter covered by the test; and
generating an overall comprehension indicator for the test based at least in part upon the first and second test-level comprehension indicators.

14. The method of claim 13, wherein generating the second test-level comprehension indicator comprises:
determining a total amount of time spent by the particular individual on the test;
comparing the total amount of time spent by the particular individual on the test to an average amount of time spent by other individuals on the test; and
generating the second test-level comprehension indicator based at least in part upon the comparison of the total amount of time spent by the particular individual on the test to the average amount of time spent by other individuals on the test.

15. The method of claim 13, wherein generating the second test-level comprehension indicator comprises:
analyzing the responses provided by the particular individual to the test questions to determine whether there are any patterns that would suggest guessing by the particular individual; and
generating the second test-level comprehension indicator based at least in part upon the determination of whether there are any patterns that would suggest guessing by the particular individual.

16. The method of claim 13, wherein the test data further comprises metadata for each test question that specifies one or more concepts tested by each test question, and wherein generating the second test-level comprehension indicator comprises:
determining a plurality of concepts that are tested by the test questions on the test;
for each concept in the plurality of concepts, generating a sub indicator for that concept that indicates how well the particular individual performed on test questions that test that concept, thereby generating a plurality of sub indicators; and
generating the second test-level comprehension indicator based at least in part upon the plurality of sub indicators.

17. The method of claim 13, wherein the test data further comprises metadata that specifies how many points are allocated to each test question, and wherein generating the second test-level comprehension indicator comprises:
determining whether the particular individual targeted test questions with higher point values;
in response to a determination that the particular individual targeted test questions with higher point values, determine how well the particular individual performed on the test questions with higher point values; and
generating the second test-level comprehension indicator based at least in part upon how well the particular individual performed on the test questions with higher point values.

18. The method of claim 13, wherein the test information indicates an end time at which the particular individual completed the test, and wherein generating the second test-level comprehension indicator comprises:
determining how many responses to test questions were provided by the particular individual during a time period that immediately preceded the end time; and
generating the second test-level comprehension indicator based at least in part upon how many responses to test questions were provided by the particular individual during a time period that immediately preceded the end time.

19. The method of claim 13, wherein generating the second test-level comprehension indicator comprises:
generating a plurality of sub indicators; and
generating the second test-level comprehension indicator based at least in part upon the plurality of sub indicators.

20. The method of claim 1, further comprising:
administering the test to the particular individual; and
while administering the test to the particular individual, recording information that includes a time at which the particular individual began taking the test, a time at which the particular individual completed taking the test, at least one start time for a particular test question that indicates when the particular individual selected the particular test question, at least one start time for another test question that indicates when the particular individual selected the other test question, at least one response provided by the particular individual for the particular test question, and a time at which the at least one response was provided by the particular individual.

21. The method of claim 20, further comprising:
analyzing the recorded information to determine how much time the particular individual spent on each test question and whether the particular individual selected and then skipped any of the test questions without providing a response.

22. The method of claim 20, further comprising:
analyzing the recorded information to determine how much time the particular individual spent on each test question, whether the particular individual selected and then skipped any of the test questions without providing a response, and whether the particular individual changed his/her response to any of the test questions.

23. A computing system configured to perform operations comprising:
accessing a set of test information pertaining to a test, wherein the test comprises a plurality of test questions and has been taken by at least a particular individual, and wherein the test information comprises responses provided by the particular individual to the test questions and behavioral information that indicates test taking behavior of the particular individual while taking the test;
for each test question in at least a subset of the plurality of test questions, generating a question-level comprehension indicator for the test question that indicates how well the particular individual understood one or more concepts tested by the test question, wherein the question-level comprehension indicator for the test question is generated based, at least in part, upon the behavioral information, and wherein a question-level comprehension indicator is generated for each of the test questions in the at least a subset of test questions, thereby giving rise to a plurality of question-level comprehension indicators; and
generating, based at least in part upon the plurality of question-level comprehension indicators, a first test-level comprehension indicator for the test, which indicates how well the particular individual understood subject matter covered by the test.

24. A computer-readable storage medium storing instructions which, when executed by one or more processors, cause the one or more processors to perform operations comprising:
accessing a set of test information pertaining to a test, wherein the test comprises a plurality of test questions and has been taken by at least a particular individual, and wherein the test information comprises responses provided by the particular individual to the test questions and behavioral information that indicates test taking behavior of the particular individual while taking the test;
for each test question in at least a subset of the plurality of test questions, generating a question-level comprehension indicator for the test question that indicates how well the particular individual understood one or more concepts tested by the test question, wherein the question-level comprehension indicator for the test question is generated based, at least in part, upon the behavioral information, and wherein a question-level comprehension indicator is generated for each of the test questions in the at least a subset of test questions, thereby giving rise to a plurality of question-level comprehension indicators; and
generating, based at least in part upon the plurality of question-level comprehension indicators, a first test-level comprehension indicator for the test, which indicates how well the particular individual understood subject matter covered by the test.
